(19) United States
(12) Patent Application Publication
(10) Pub. No.: US 2016/0073235 A1
(43) Pub. Date: Mar. 10, 2016

(54) Systems and Methods for Providing Real-Time Dynamic Display of Underground Facilities

(71) Applicant: Verizon Patent and Licensing Inc., Arlington, VA (US)

(72) Inventors: Nityanand Sharma, Temple Terrace, FL (US); Jagannath Rangarajan, Irving, TX (US); Muhammad Shaphy, Irving, TX (US); Harold Rex Slay, JR., Temple Terrace, FL (US); Robert Kneusel, Temple Terrace, FL (US)

(21) Appl. No.: 14/477,238

(22) Filed: Sep. 4, 2014

(51) Int. Cl. H04W 4/02

(52) U.S. Cl. CPC H04W 4/023

(57) ABSTRACT

A system and method for providing a dynamic display of buried facilities at a user device. The system receives the device's current location. The system compares the device's current location with a set of location points stored in a database and associated with one or more underground facilities. If the current location of the device is within a predetermined distance of one or more of the location points in the database, the system generates a dynamic display of the underground facility associated with the one or more location points. The dynamic display includes a graphical representation of the underground facility overlaid on a map-like interface on the user device showing the location of the underground facility relative to the current location of the user device. The graphical representation may include facility information, such as the name of the cable pair, the type of cable, the status, the transmission speed, splicing information, customer information, etc.

### BACKGROUND INFORMATION

Telecommunications providers often use buried facilities (fibers and cables) as part of telecommunications networks (e.g., cable TV, phone, internet, etc). The facilities are marked on physical maps and diagrams that may be provided to service technicians in the field. The maps and diagrams may be cumbersome to carry and organize, and are limited in the amount of information they can provide and in the geographical areas they can depict.

These and other drawbacks exist.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system according to a particular embodiment;

FIG. 2 is a schematic diagram of a hardware component of the system of a particular embodiment;

FIGS. 3A-3C depict graphical representations of an underground facility, according to a particular embodiment; and

FIG. 4 is a block diagram of a method of a particular embodiment.

### DETAILED DESCRIPTION OF PREFERRED EMBODIMENTS

A system and method described here may include various embodiments for providing a dynamic display of buried facilities at a user device. The dynamic facility display may provide a view of buried facilities to the user of the user device based on the user's location, direction of travel, speed, etc. The buried facilities may include underground network cables. One or more servers may receive location data from the user device. The location data may include latitude, longitude, altitude, speed, direction of travel, etc. The one or more servers may compare the location data to a database of location points that have been previously associated with one or more buried facilities. The one or more servers may identify a buried facility that is within a predetermined distance of the user device's current location based on the location data. The one or more servers may return a response that provides a graphical representation of the buried facility on the user device. The graphical representation may be overlaid on a mapping application. The graphical representation may be overlaid on a head-mounted display. The graphical representation may include facility information, such as the name of the cable pair, the type of cable, the status, the transmission speed, splicing information, customer information, etc. The graphical representation may be updated at regular intervals as the location of the user device changes.

The description below describes interface modules, lookup modules, dynamic display modules, facility data modules, user devices, servers, data storages, and networks that may include one or more modules, some of which are explicitly shown while others are not. As used herein, the term “module” may be understood to refer to computing software, firmware, hardware, and/or various combinations thereof. It is noted that the modules are examples. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

It is further noted that software described herein may be tangibly embodied in one or more physical media, such as, but not limited to, a compact disc (“CD”), a digital versatile disc (“DVD”), a floppy disk, a hard drive, read only memory (“ROM”), random access memory (“RAM”), as well as other physical media capable of storing software, and/or combinations thereof. The functions described as being performed at various components may be performed at other components, and the various components may be combined and/or separated. Other modifications also may be made.

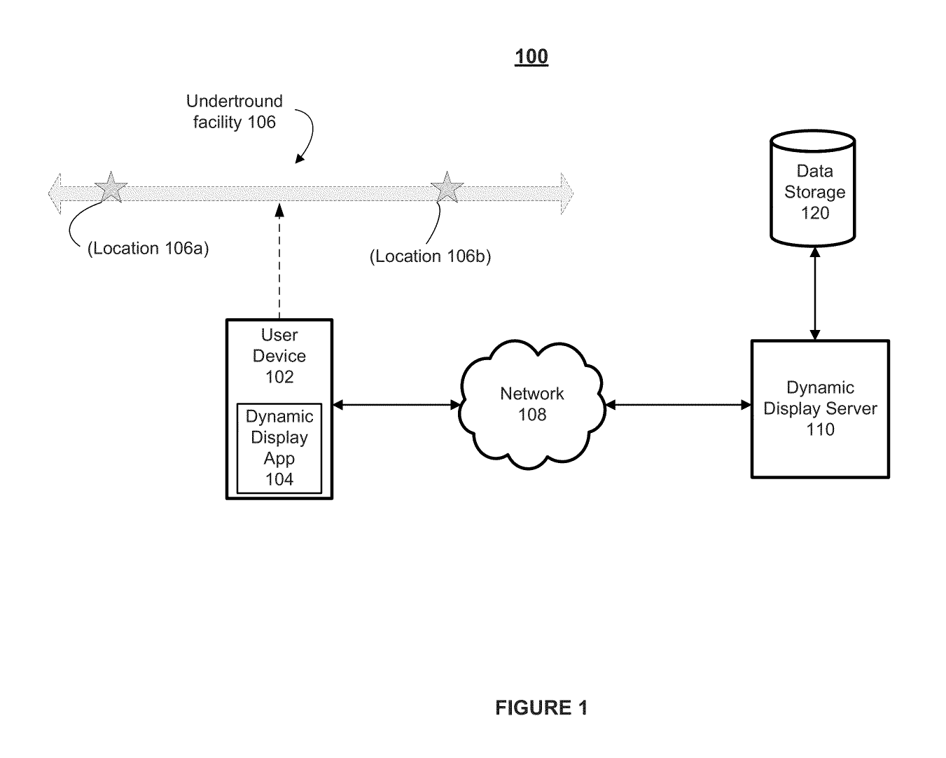

FIG. 1 is a schematic diagram illustrating a system 100 according to a particular embodiment. System 100 may include user device 102 having a dynamic display application 104, an underground facility 106, a network 108, a dynamic display server 110, and data storage 120. Although elements of system 100 may be described as a single device, it will be appreciated that multiple instances of these devices may be included in system 100, such as, for example, multiple user devices, multiple dynamic display servers, multiple underground facilities, multiple data storages, and multiple networks.

User device 102 may be, for example, but not limited to, smartphone, a tablet computer, a head-mounted display, a cellular telephone, Session Initiation Protocol (“SIP”) phone, software client/phone, a laptop/notebook, a server, a module, a satellite phone, a personal digital assistant (“PDA”), a handheld PC, a handheld MP3 player, a handheld video player, a personal media player, a gaming device, a thin system, a fat system, a network appliance, and/or other mobile communication device that may be capable of transmitting and/or receiving data. Also, user device 102 may include one or more transmitters, receivers, and/or transceivers to transmit and/or receive one or more signals to and/or from other components depicted in FIG. 1, including, for example, dynamic display server 110.

Network 108 may be a wireless network, a wired network, or any combination of wireless network and wired network. For example, network 108 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and/or receiving a data signal. In addition, network 108 may include, without limitation, telephone line, fiber optics, IEEE Ethernet 802.3, a wide area network (“WAN”), a local area network (“LAN”), or a global network such as the Internet. Also, network 108 may support, an Internet network, a wireless communication network, a cellular network, or the like, or any combination thereof. Network 108 may be a 4G network that complies with the International Mobile Telecommunications Advanced (IMT-Advanced) specification. Network 108 may be a Long Term Evolution (LTE) network. Network 108 may be a LTE Advanced (LTE-A) network. Network 108 may be a Mobile WiMAX (IEEE 802.16e). Network 108 may be a Mobile WiMAX Release 2 (IEEE 802.16m) network. Network 108 may further include one, or any number of the exemplary types of networks mentioned above operating as a stand-alone network or in cooperation with each other. Network 108 may utilize one or more protocols of one or more network elements to which it is communicatively coupled. Network 108 may translate to or from other protocols to one or more protocols of network devices. Although network 108 is depicted as one network, it should be appreciated that according to one or more embodiments, network 108 may comprise a plurality of interconnected networks, such as, for example, a service provider network, the Internet, a broadcaster's network, a cable television network, corporate networks, and home networks.

The components depicted in FIG. 1 may transmit and receive data to and from network 108 representing broadcast content, user request content, parallel search queries, parallel search responses, and other data. The data may be transmitted and received utilizing a standard telecommunications protocol or a standard networking protocol. For example, one embodiment may utilize Session Initiation Protocol (“SIP”). In other embodiments, the data may be transmitted and/or received utilizing other Voice Over IP (“VOIP”) or messaging protocols. For example, data may also be transmitted and/or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving broadcast or parallel search data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 108 may use standard wireless protocols including IEEE 802.11a, 802.11b and 802.11g. Network 108 may also use protocols for a wired connection, such as an IEEE Ethernet 802.3.

Data storage 120 may be network accessible storage and may be local, remote, or a combination thereof to the components depicted in FIG. 1. Data storage 120 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, data storage 120 may be a database, such as an Oracle database, a Microsoft SQL Server database, a DB2 database, a MySQL database, a Sybase database, an object oriented database, a hierarchical database, or other database. Data storage 120 may utilize flat file structures for storage of data. Data storage 120 may be communicatively coupled to gridsearch system 110, or to any other component depicted in FIG. 1. Any of the other components depicted in FIG. 1 may include one or more data storages as well.

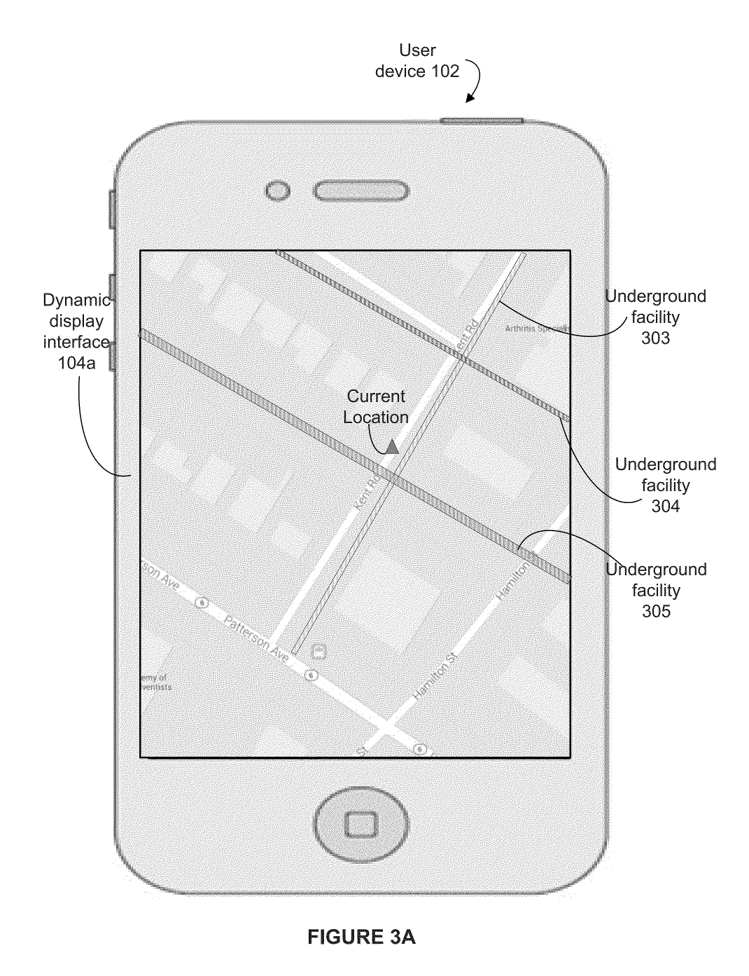

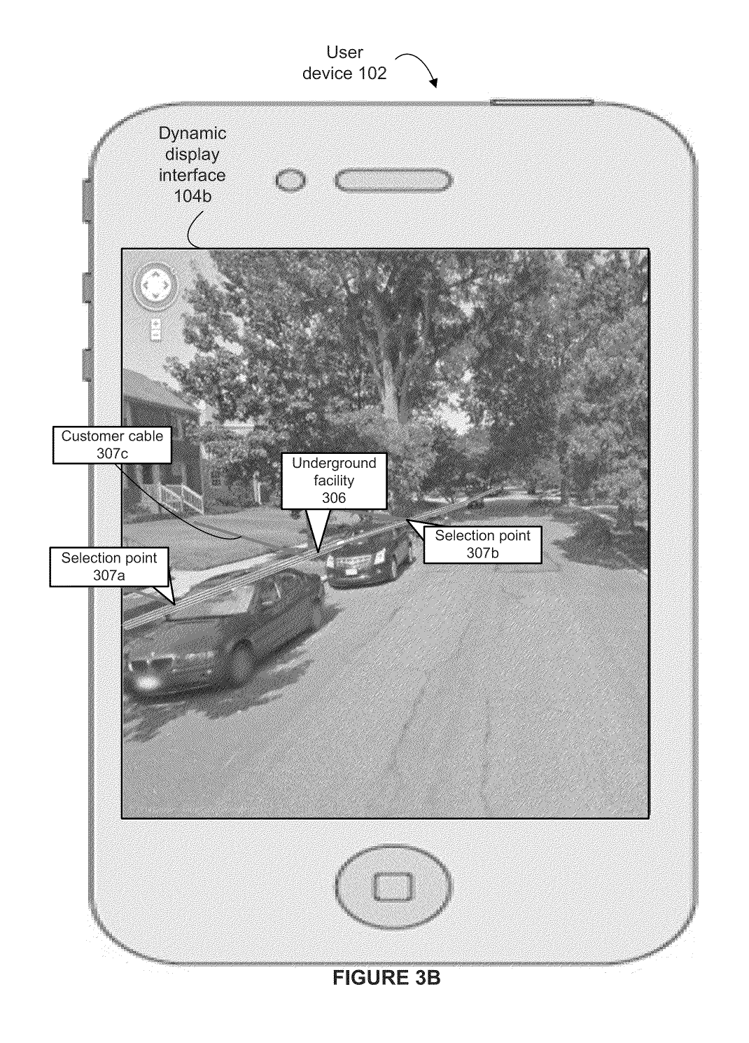

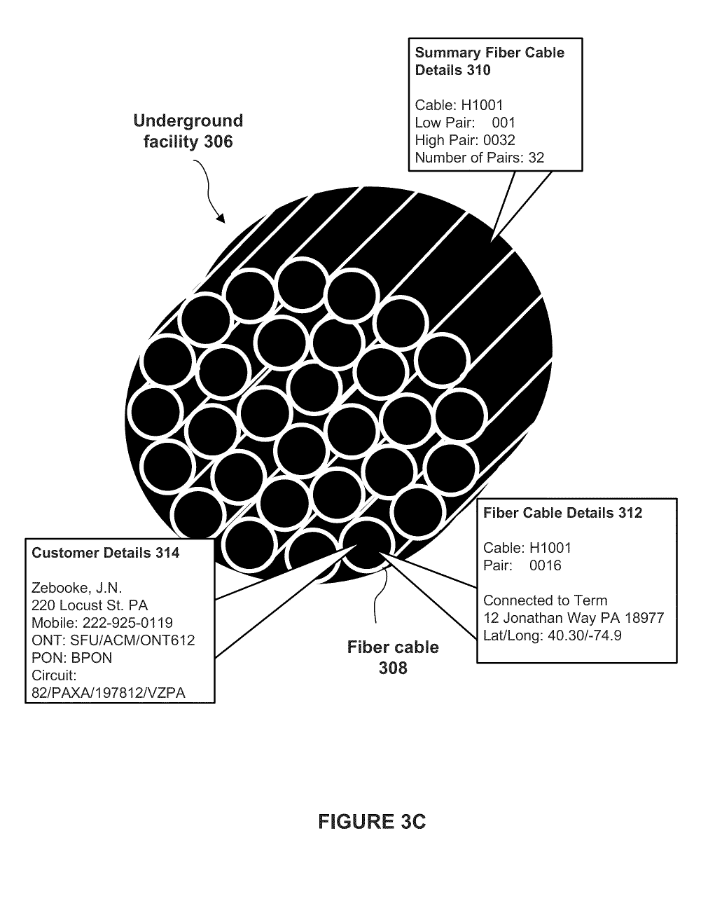

User device 102 may include a dynamic display application 104. Dynamic display application 104 may be a combination of software and hardware configured to provide an interface for user device 102 to exchange data with dynamic display server 110. Dynamic display app 104 may provide a map-like display on user device 102, as shown in FIGS. 3A and 3B.

Underground facility 106 may comprise a bundle of underground network cables and fibers that provide telecommunications services to residences and businesses. Telecommunications services may include cable TV, phone, internet, etc. Underground facility 106 may have been previously installed by a service provider. Underground facility 106 may be associated with multiple location points, including, for example, location 106a and location 106b. When cables are placed in underground facility 106 (e.g., by technicians and/or engineers), those individuals may record location data associated with the location points of underground facility 106. The location data for each location point may be stored in data storage 120 and associated with one or more underground facilities. The location data may include GPS coordinates associated with each location point (e.g., location points 106a and 106b). The location data may include a physical address associated with each location point (e.g., locations 106a and 106b). Each underground facility may be associated with a plurality of location points in data storage 120. Data storage 120 may include facility data associated with each underground facility, as will be described in greater detail below in reference to FIG. 3.

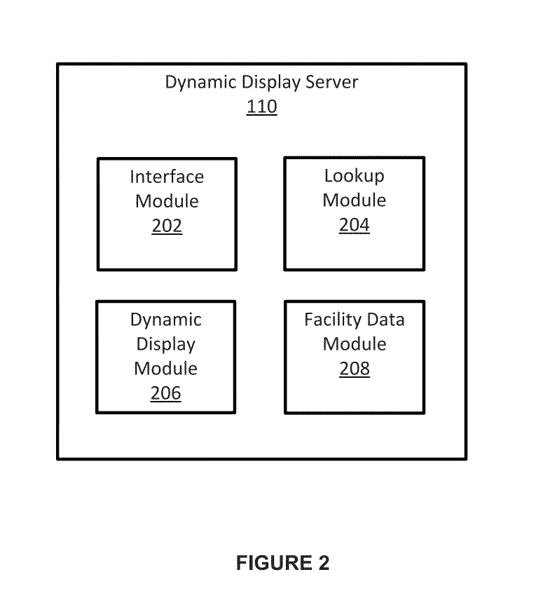

Dynamic display server 110 may include one or more devices, modules, and/or components for providing routing information for transmitting data over a network, such as, for example, an IP network and/or a PSTN. For example, dynamic display server 110 may be part of, or communicatively coupled to, network 108, and may receive data from user device 102. Dynamic display server 110 may include an interface module, a lookup module, a dynamic display module, and a facility data module as described herein in reference to FIG. 2. In other embodiments, dynamic display server 110 may be implemented as an application on user device 102. Dynamic display server 110 may comprise one or more network enabled computers. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device.

FIG. 2 is a block diagram of a hardware component of an exemplary embodiment of dynamic display server 110. For example, dynamic display server 110 may include an interface module 202, a lookup module 204, a dynamic display module 206, and a facility data module 208. It is noted that modules 202, 204, 206, and 208 are exemplary and the functions performed by one or more of the modules may be combined with that performed by other modules. The functions described herein as being performed by modules 202, 204, 206, and 208 may also be separated and may be performed by other modules at devices local or remote to dynamic display server 110. The modules may each be a computer program or an appropriately programmed computer, such as a mainframe or personal computer, or may include a plurality of such computers cooperating to perform the functionality described herein. Modules 202, 204, 206, and 208 may also communicate with data storage 120. Modules 202, 204, 206, and 208 may also be coupled to or integrated with dynamic display server 110. For example, modules 202, 204, 206, and 208 may be external devices that are wirelessly coupled and/or communicatively coupled to dynamic display server 110 via an interface port which may include, without limitation, USB ports, system bus ports, or Firewire ports and other interface ports. Further, computer code may be installed on dynamic display server 110 to control and/or operate a function of interface module 202, lookup module 204, dynamic display module 206, and/or facility data module 208.

Interface module 202 may be configured to interface with user device 102. Interface module 202 may represent a network connection between a user device and dynamic display server 110. Interface module 202 may receive data from user device 102 and provide data to user device 102. The user of user device 102 may interact with interface module 202 using manual input (e.g., typing into a keyboard or keypad, etc.), voice input, touch screen input, graphical input (e.g., camera or camcorder) and/or any other method for inputting information or data to user device 102. Interface module 202 a dynamic facility display for user device 102. User device 102 may access interface module 202 via dynamic display application 104.

Interface module 202 may receive device location data from user device 102. User device 102 may transmit its device location data to interface module 202 in response to the user entering a command in dynamic display application 104. User device 102 may automatically and periodically transmit its device location data to interface module 202. The device location data may identify the current geographical location of user device 102. Device location data may include latitude, longitude, and altitude coordinates. Device location data my include a physical address. Device location data may include the current velocity of user device 102 (e.g., the speed and direction of travel), as measured by a gyroscope, compass, and/or accelerometer in user device 102 (e.g., if the user is traveling in a car).

Interface module 202 may provide the received device location data to lookup module 204, dynamic display module 206, and/or facility data module 208. Lookup module 204 may search data storage 120 for location points that are within a predetermined distance of the device location data received from user device 102. The predetermined distance may be based on the speed of user device 102. If user device 102 is moving at 60 mph, lookup module 204 may search for location points in data storage 120 that are within a 1 mile radius of the location of user device 102. In various embodiments, if user device 102 is moving at 80 mph, lookup module 204 may search for location points in data storage 120 that are within a 1.5 mile radius of the location of user device 102. In various embodiments, if user device 102 is stationary, lookup module 204 may search for location points in data storage 120 that are within a 0.5 mile radius of the location of user device 102.

Lookup module 204 may return a group of one or more location points that are within the predetermined distance of user device 102, based on the search of data storage 120. The one or more location points may be associated with one or more underground facilities (such as underground facility 106). For example, user device 102 may be within 100 feet of location 106a. Lookup module 204 may search data storage 120, compare the device location data associated with user device 102 with the location data associated with location 106a and determine that user device 102 is currently within 100 feet of location 106a. Based on this match, facility data module 208 may retrieve facility data associated with underground facility 106 at location 106a. Facility data may have been previously stored in data storage 120 and associated with underground facility 106 and/or with the various location points along underground facility 106. Facility data may include the type of cable (or cables) in underground facility 106, the name of the cable pair, the status of the cable pair, splice information, the name and address of a customer associated with the cable, the depth at which the cables are buried, the account number of the customer associated with the cable, and other information. The facility data may be associated with the specific location data for that portion of the underground facility (e.g., the facility data may change depending on the specific location along the underground facility). Facility data module 208 may retrieve facility data associated with other location points along underground facility 106 that are within the predetermined distance of the location of user device 102. For example, if location 106b is within 0.5 miles of user device 102, facility data module 208 may retrieve the facility data associated with location 106b.

Dynamic display module 206 may create a graphical representation of the underground facility based on the location data associated with the underground facility and the facility data. Dynamic display module 206 may provide the graphical representation to user device 102 via dynamic display application 104. In some embodiments, dynamic display application 104 may create the graphical representation using data received from dynamic display module 206. The graphical representation may be integrated with a map-like display on user device 102. The graphical representation may comprise a graphical representation of one or more underground facilities that are within the predetermined distance of user device 102. The graphical representation may be overlaid on a “birds-eye view” map-display, such as dynamic display 104a shown in FIG. 3A. The graphical representation may be overlaid on a “street view” display, such as dynamic display 104b shown in FIG. 3B. The dynamic display interface 104a may show streets, businesses, landmarks, and other geographic features on the map.

FIG. 3A shows an embodiment of a dynamic display interface 104a on user device 102. Dynamic display interface 104a may be a graphical user interface (GUI). Dynamic display interface 104a shows a map of the current location of user device 102. The graphical representation provided by dynamic display module 206 includes underground facility 303, underground facility 304, and underground facility 305 overlaid on the map of dynamic display interface 104a. The positions of underground facility 303, underground facility 304, and underground facility 305 on dynamic display interface 104a may be based on the device location data received from user device 102 as compared to location data associated with underground facilities 303-305 based on the process described above involving modules 202-208. Dynamic display interface 104a may allow the user of user device 102 to “zoom in” or “zoom out” on the map, “pan”, or move the area of the map that is being displayed on user device 102. In various embodiments, the graphical representation of an underground facility may become more detailed as a user zooms in on dynamic display interface 104a. For example, if a user zooms in on underground facility 305, dynamic display module 206 may provide additional data showing individual cables/fibers that branch off the underground facility to service customers. The size and color of the graphical representation of each underground facility may vary based on the number of cables in each underground facility, the speed, the depth at which they are buried, etc. For example, if underground facility 305 includes more than 50 cables, it may be displayed in a red color on dynamic display interface 104a. If it includes less than 10 cables, it may be displayed as yellow.

FIG. 3B shows an embodiment of a dynamic display interface 104b on user device 102. Dynamic display interface 104b may be a graphical user interface (GUI). Dynamic display interface 104b shows a “street view” of the current location of user device 102. If user device 102 includes a head-mounted display, the dynamic display interface 104b may be overlaid on the user's current view through the head-mounted display. Dynamic display interface 104b includes a graphical representation of underground facility 306, based on the device location data associated with user device 102 and the location data associated with the various location points of underground facility 306. The graphical representation includes customer cables, such as customer cable 307c that branches from underground facility 306. The location of the graphical representation of underground facility 306 on dynamic display interface 104b relative to the view is based on the location data associated with underground facility 306 relative to the device location data (including the speed and direction of travel). As user device 102 moves, the device location data may be constantly re-transmitted from user device 102 (or retrieved by interface module 202) at regular intervals (e.g., every 5 seconds), and dynamic display module 206 may updated the graphical representation based on the updated location data from user device 102 (using the same process described above).

The graphical representation of underground facility 303, 304, 305, and 306 may include interactive selection points. The selection points may coincide with the location points for the underground facility. The graphical representation of the underground facility may be continuously selectable. The user may be able to select a portion of the underground facility and view facility data associated with that portion of the underground facility. As shown in FIG. 3B, the graphical representation of underground facility 306 may include multiple selection points 307a and 307b. The selection points may coincide with location points (e.g., location points 106a and 106b) along facility 306. The location points may be associated with location data and facility data associated with that specific location on of the underground facility, and stored in data storage 120. A user of user device 102 may view facility data associated with that spot on the underground facility by selecting it on the dynamic display interface 104a and/or dynamic display interface 104b. The user may select the selection point using a keypad, touchscreen, scroll wheel, spoken command, etc, via user device 102.

FIG. 3C shows an embodiment of facility data associated with selection point 307a of underground facility 306. The graphical representation may be presented on the display of user device 102 in response to interface module 202 receiving an indication that the user has selected a certain selection point. Facility data module 208 may provide facility data for display on user device 102. The dynamic display may include a cross-section of the underground facility 306. In this example, the cross section of underground facility 306 is shown at the location associated with selection point 307a in response to the user selecting selection point 307a on dynamic display interface 104b. The underground facility 306 may include multiple fiber cables, which are represented graphically, including fiber cable 308. The dynamic display may include summary fiber cable details 310. The summary details 310 may include the name of the cable pair (in this example, H1001). The summary details 310 may include the number of pairs (in this example, 32). The summary details 310 may include the number of the low pair (001) and the number of the high pair (0032).

The graphical representation of each of the individual fiber cables may be selectable. For example, the user may select fiber cable 308. Facility data module 208 may provide the facility data associated with fiber cable 308. The facility data may include fiber cable details 312. The details may include the name of the cable pair (same as shown in summary details 310). The details 312 may include the specific cable number of fiber cable 308 (in this example, cable number 0016). The details may include the address associated with the terminal and binding posts. In this example, fiber cable 308 may be connected to the address of 12 Jonathan Way, Pa., 18977. The details may include the latitude and longitude coordinates associated with the selection point. This indicates the specific location of this portion of fiber cable 308 (in this example, latitude 40.30 and longitude −74.9). The details may include the speed of the fiber. The details may include the depth at which the cable is buried at a given location point.

The facility data may include customer details 314. Facility data module 208 may retrieve customer data associated with each fiber cable in each underground facility. This data may be stored in data storage 120. For a specific fiber cable, the customer details 314 may include the name or initials of the customer that is serviced by the cable. The details 314 may include contact information associated with the customer (e.g., a phone number, an email address, social media information, etc). The details 314 may include one or more account numbers associated with the customer. The details 314 may include a physical address of the customer (in this example, 220 Locust St, Pa.). The details 314 may include the customer's passive optical network (PON) view providing details of how optical splitters are used to enable the fiber service at the customer's premises. The details 314 may include details of the Optical Line Terminal (OLT), Optical Network Terminals (ONT), and the details of the fibers and splitters between them. In this way, a field service technician may view specific information associated with a buried fiber cable based on the technician's current location relative to the location of the fiber cable.

In various embodiments, the graphical representation of underground facilities shown in FIGS. 3A-3C may be three-dimensional. The user may change the point of view for viewing an underground facility on user device 102. In various embodiments, the user may be able to view a graphical representation of aerial cables (e.g., above-ground cables attached to telephone lines), using the same process described above.

In various embodiments, the graphical representation of the underground facility 306 cross-section shown in FIG. 3C may be overlaid on top of dynamic display interface 104a and/or 104b by dynamic display module 206 in response to the user selecting an underground facility and/or one or more selection points along the underground facility on the interface. The user may be able to view facility data associated with multiple underground facilities and/or multiple selection points simultaneously.

In various embodiments, dynamic display module 206 may allow the user to filter the view shown in FIGS. 3A-3C based on various inputs received from the customer. The graphical representation may be filtered based on the cable pair name (e.g., the user may provide the name “H1001” and be presented with a graphical representation that only displays underground facility 306). The graphical representation may be filtered based on the depth (or range of depths) at which an underground facility is buried (e.g., the user may request to only view underground facilities that are buried between 2-4 feet underground). The graphical representation may be filtered based on customer information (e.g., the user may enter the name, address, GPS data, and/or account number of a specific customer and be presented with a dynamic display that only shows the underground facility (or facilities) that serve that customer). The graphical representation may be filtered based on geographical coordinates and/or an address. The graphical representation may be filtered based on the type of service provided (e.g., the user may request to see only underground facilities that include internet cables). The graphical representation may be filtered based on other facility data.

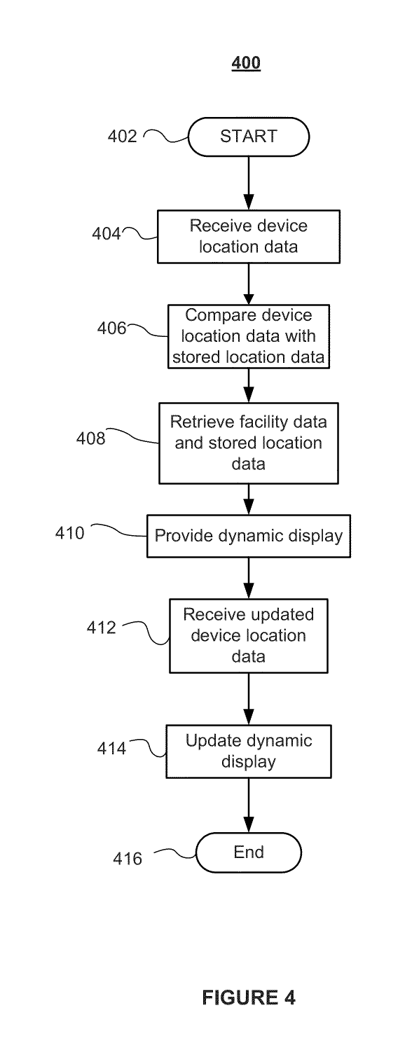

FIG. 4 is a flowchart illustrating the functionality of a method according to an embodiment of the disclosure. This method is provided by way of example, as there are a variety of ways to carry out the methods described herein. Method 400 shown in FIG. 4 may be executed or otherwise performed by one or a combination of various systems. The method 400 may be carried out through system 100 of FIG. 1 and/or the one or more modules shown in FIG. 2, by way of example, and various elements of FIG. 1 and FIG. 2 are referenced in explaining method 400 of FIG. 4. Each block shown in FIG. 4 represents one or more processes, methods, or subroutines carried out in method 400. Method 400 may begin at block 402.

At block 404, method 400 may receive device location data from a user device. The location data may be GPS coordinates and/or a physical address. In various embodiments, the device location data may further include the device velocity (e.g., speed and direction of travel). At block 406, method 400 may compare the device location data with stored location points. The stored location points may be associated with one or more underground facilities in a database. The stored location points may comprise location data (e.g., GPS coordinates and/or a physical address). The stored location points may be compared with the device location data to determine whether the device is within a predetermined distance of one or more location points in the database. The predetermined distance may vary based on the velocity of the user device. If the device is within a predetermined distance of the one or more location points, method 400 may proceed to block 408. Otherwise, method 400 may end. At block 408, method 400 may retrieve facility data and location data from the database associated with location points that were determined to be within a predetermined distance of the device location in block 406. The facility data may be data associated with an underground facility and/or one or more location points of the underground facility. Facility data may include the type of cable (or cables) in underground facility, the name of the cable pair, the status of the cable pair, splice information, the name and address of a customer associated with the cable, the depth at which the cables are buried, the account number of the customer associated with the cable, and other information.

At block 410, method 400 may provide a dynamic facility display for the user device. The dynamic facility display may include a graphical representation of one or more underground facilities associated with the retrieved location data and facility data from blocks 406 and 408. The graphical representation may be provided on a map-like interface on the user device. The graphical representation may be provided on a street-view interface on the user device. The graphical representation may be overlaid on a head-mounted display of the user device, based on which direction the head mounted display is facing. The graphical representation may include a three-dimensional representation of the one or more underground facilities, based on the location data and facility data associated with the location points from blocks 406 and 408. Embodiments of the graphical representation are shown in FIGS. 3A-3C.

The user may be able to view facility data associated with a specific location along the underground facility, as shown in FIG. 3C. The user may select the location on the interface of the user device. The dynamic display may show facility data associated with that location and section of the underground facility. At block 412, method 400 may receive updated device location data. The updated data may be transmitted in response to the user device being moved. The updated device location data may be transmitted regularly by the user device. The device location data may be regularly polled by dynamic display server 110. At block 414, method 400 may update the dynamic facility display based on the updated device location data, using the same process described in blocks 406-410. In this way, the graphical representations of underground facilities on the user device may be updated as the user device changes locations.

The various computing devices above (including phones and network equipment), generally include computer-executable instructions, where the instructions may be executable by one or more processors. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor or microprocessor receives instructions, e.g., from a memory, a computer-readable medium, etc., and executes these instructions, thereby performing one or more processes, including one or more of the processes described herein. Such instructions and other data may be stored and transmitted using a variety of computer-readable media.

Databases, data repositories or other data stores described herein, such as the data storage 120, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system, comprising:
a processor; and
a memory comprising computer-readable instructions which when executed by the processor cause the processor to:
receive geolocation data from a user device, wherein the geolocation data comprises a current location of the user device;
compare the geolocation data with one or more locations stored in a data storage medium;
retrieve at least one first location and facility data associated with the at least one first location based on the comparison between the geolocation data and the one or more locations, wherein the at least one first location and the facility data are associated with at least one underground facility, wherein the at least one underground facility comprises one or more transmission lines; and
provide a graphical representation of the at least one underground facility for display at the user device, wherein the graphical representation of the at least one underground facility is based on the at least one first location, the facility data, and the geolocation data.

2. The system of claim 1, wherein retrieve the at least one first location and facility data associated with the at least one first point based on a comparison between the geolocation data and the one or more location comprises retrieving the at least one first location if it is within a first distance of the current location of the user device.

3. The system of claim 2, wherein the geolocation data further comprises a current velocity of the user device, wherein the first distance is based on the current velocity.

4. The system of claim 1, wherein the geolocation data, one or more locations, and at least one first location comprises at least one of GPS coordinates and a physical address.

5. The system of claim 1, wherein the graphical representation is overlaid on an interactive map showing the location of the underground facility relative to the current location of the user device.

6. The system of claim 5, wherein the graphical representation includes interactive facility data, wherein the facility data comprises one or more of a number of transmission lines in the underground facility, a type of transmission line, a name and address of a customer associated with at least one of the one or more transmission lines, a depth of the underground facility, and a transmission speed associated with at least one of the one or more transmission lines.

7. The system of claim 6, wherein the memory comprises additional computer-readable instructions which when executed by the processor cause the processor to:
receive, from the user device, a selection of a specific point associated with the graphical representation; and
provide interactive facility data for display on the user device, wherein the interactive facility data is associated with the specific point.

8. The system of claim 6, wherein the memory comprises additional computer-readable instructions which when executed by the processor cause the processor to:
receive a request from the user device to filter the graphical representation based on the facility data to display a specific one of the one or more transmission lines; and
provide a filtered graphical representation to the user device based on the request.

9. The system of claim 1, wherein the memory comprises additional computer-readable instructions which when executed by the processor cause the processor to:
receive, from the user device, updated geolocation data, wherein the updated geolocation data indicates a new current location of the user device; and
provide a second graphical representation of the at least one underground facility for display at the user device, wherein the second graphical representation of the at least one underground facility is based on the at least one first location, the facility data, and the updated geolocation data.

10. A method, comprising:
receiving geolocation data from a user device, wherein the geolocation data comprises a current location of the user device;
comparing the geolocation data with one or more locations stored in a data storage medium;
retrieving at least one first location and facility data associated with the at least one first location based on the comparison between the geolocation data and the one or more locations, wherein the at least one first location and the facility data are associated with at least one underground facility, wherein the at least one underground facility comprises one or more transmission lines; and
providing a graphical representation of the at least one underground facility for display at the user device, wherein the graphical representation of the at least one underground facility is based on the at least one first location, the facility data, and the geolocation data.

11. The method of claim 10, wherein retrieve the at least one first location and facility data associated with the at least one first point based on a comparison between the geolocation data and the one or more location comprises retrieving the at least one first location if it is within a first distance of the current location of the user device.

12. The method of claim 11, wherein the geolocation data further comprises a current velocity of the user device, wherein the first distance is based on the current velocity.

13. The method of claim 10, wherein the geolocation data, one or more locations, and at least one first location comprises at least one of GPS coordinates and a physical address.

14. The method of claim 10, wherein the graphical representation is overlaid on an interactive map showing the location of the underground facility relative to the current location of the user device.

15. The method of claim 14, wherein the graphical representation includes interactive facility data, wherein the facility data comprises one or more of a number of transmission lines in the underground facility, a type of transmission line, a name and address of a customer associated with at least one of the one or more transmission lines, a depth of the underground facility, and a transmission speed associated with at least one of the one or more transmission lines.

16. The method of claim 15, further comprising:
receiving, from the user device, a selection of a specific point associated with the graphical representation; and
providing interactive facility data for display on the user device, wherein the interactive facility data is associated with the specific point.

17. The system of claim 15, further comprising:
receiving a request from the user device to filter the graphical representation based on the facility data to display a specific one of the one or more transmission lines; and
providing a filtered graphical representation to the user device based on the request.

18. The method of claim 10, further comprising:
receiving, from the user device, updated geolocation data, wherein the updated geolocation data indicates a new current location of the user device; and
providing a second graphical representation of the at least one underground facility for display at the user device, wherein the second graphical representation of the at least one underground facility is based on the at least one first location, the facility data, and the updated geolocation data.
